(19) United States
(12) Patent Application Publication
(10) Pub. No.: US 2005/0043207 A1
(43) Pub. Date: Feb. 24, 2005

(54) Cleaning composition and method for removal of polysilicate residue

(76) Inventors: Eric Aubay, Princeton, NJ (US); Elizabeth Baluyot, Hamilton, NJ (US); Nicholas Fradette, Verona, NJ (US)

Correspondence Address: RHODIA INC.;CN 7500, 259 PROSPECT PLAINS ROAD, CRANBURY, NJ, 08512, US

(21) Appl. No.: 10/881,442

(22) Filed: Jun. 30, 2004

Related U.S. Application Data
(60) Provisional application No. 60/483,873, filed on Jun. 30, 2003.

(51) Int. Cl. C11D 1/00

(52) U.S. Cl. 510/490

(57) ABSTRACT

The invention is directed to a cleaning composition of sodium hydroxide, sodium fluoride, and an amphoteric surfactant for removing polysilicate residue from metal surfaces of poultry processing equipment. The invention is also directed to a method of removing polysilicate residue from metal surface of poultry processing equipment by contacting the metal surface with a cleaning composition of sodium hydroxide, sodium fluoride, and an amphoteric surfactant. The cleaning composition may be used at room temperature for about 30 minutes or at elevated temperature of at least about 130° F. for about 10 minutes.

### FIELD OF THE INVENTION

This invention relates generally to industrial cleaners and their use in cleaning industrial equipment surfaces and parts. More particularly, the invention relates to compositions and methods for removing polysilicate deposits from industrial poultry processing equipment.

### BACKGROUND OF THE INVENTION

Poultry is processed, after slaughtering, by scalding to assist in defeathering, defeathering by machine, washing, eviscerating and chilling prior to packing. For many years, poultry operations have employed high phosphate compositions, for example, trisodium phosphate to clean the carcass and remove salmonellae contamination. Thomson et al. “Phosphate and Heat Treatments to Control Salmonella and Reduce Spoilage and Rancidity on Broiler Carcasses Poultry Science pp.139-143, 1979 treats poultry with 6% kena phosphate which is a polyphosphate blend of 90% sodium tripolyphosphate and 10% sodium hexametaphosphate. However, due to increasing environmental concerns about the use and disposal of high-phosphate detergents new cleaning agents have been explored.

One such agent found to be of particular interest as a replacement for trisodium phosphate poultry processing solutions is sodium metasilicate. However, one draw back associated with using sodium metasilicate processing solutions is polysilicate scale or residue build-up on the processing equipment.

Conventional cleaning methods used to clean equipment after poultry processing, usually include using high temperature water at above about 130° F. at high pressures of about 600 psi. Special caustic and acid based systems may be used to enhance cleaning. These conventional cleaning processes although adequate for removing trisodium-phosphate residue, have proven ineffective in the removal of polysilicate residue.

Accordingly, there exists a need in the art for a method and composition to remove polysilicate residue from poultry processing equipment.

### SUMMARY OF THE INVENTION

The present invention is directed to a cleaning solution for removing polysilicate residue from poultry processing equipment, in particular stainless steel equipment. In one embodiment, the cleaning solution comprises sodium hydroxide; an amphoteric surfactant, and sodium fluoride. In a preferred embodiment the cleaning solution comprises from about 3-10% sodium hydroxide, from about 0.5 -5% amphoteric surfactant and about 0.5-5% sodium fluoride. The amphoteric surfactant preferably comprises aminoproprionate.

Methods of removing polysilicate scale in accordance with the invention include heating the cleaning solution to temperatures of about 130° F. or higher, contacting the equipment with the heated solution, and optionally agitating the solution while it is in contact with the poultry cleaning equipment. The solution is preferably in contact with the equipment for at least about 10 minutes. The equipment may be scrubbed after treatment with the solution. In another embodiment the method includes contacting the equipment with the cleaning solution of the invention at room temperature and optionally agitating the solution while it is in contact with the equipment. The solution of the invention is preferably in contact with the equipment for at least about 30 minutes. The equipment may be scrubbed after treatment with the solution.

### DETAILED DESCRIPTION OF INVENTION AND PREFERRED EMBODIMENTS

It has been discovered, in accordance with the invention, that a solution comprising sodium hydroxide, sodium fluoride and an amphoteric surfactant when used to remove polysilicate residue from poultry processing equipment, provides results that are better than those obtained using conventional cleaning methods. Cleaning efficacy can further be enhanced by heating the solution.

In an embodiment of the invention, a solution of sodium hydroxide, sodium fluoride, and an amphoteric surfactant are used as a cleaning solution to remove polysilicate residue from poultry processing equipment, particularly metal surfaces of the processing equipment. The solution preferably comprises from about 3% to about 10% sodium hydroxide; from about 0.5% to about 5% sodium fluoride; and from about 0.5% to about 5% amphoteric surfactant. More preferably the solution comprises about 5% sodium hydroxide, about 1% sodium fluoride and about 1% amphoteric surfactant.

Amphoteric surfactants have a positive, negative, or both charges on the hydrophilic part of the molecule in acidic or alkaline media. Any suitable amphoteric surfactant may be used. Most preferably an aminoproprionate containing amphoteric surfactant is used. The alkyl chain of the aminoproprionate is preferably between about C₄ and about C₁₂ and may be branched or linear. The aminoproprionate may also be a sodium alkyl aminoproprionate. One commercially available product which is suitable as a preferred aminoproprionate amphoteric surfactant is a low foam amphoteric surfactant sold by RHODIA Inc. under the trade name MIRATAINE JC-HA.

Other suitable amphoteric surfactants include, diproprionates such as Mirataine H2C-HA (Rhodia), sultaines such as Mirataine ASC (Rhodia), betaines such as Mirataine BET-O-30 (Rhodia), amine oxides such as Barlox 12i (Lonza) and amphoteric imidazoline derivatives in the acetate form, Miranol JEM Conc. (Rhodia), diproprionate form, Miranol C2M-SF Conc. (Rhodia), and sulfonates such as Miranol JS Conc. (Rhodia).

The selection of a specific surfactant will depend on the level of detergency, hydrotropy and foaming desired. For example, solutions that are applied using a high pressure spray will preferably contain Mirataine ASC, a low foaming surfactant, however in this case the detergency can be less than with other surfactants. In poultry plants some vertical surfaces can be descaled using a foam film and in that case a foaming surfactant such as Mirataine BET-O-30 can be used. In most cases where a good balance between detergency and foaming is desirable such as in plants where high pressure spray and immersion would be used, a low foaming amphoteric surfactant having good detergency such Mirataine JC-HA can be used. It is to be noted that a balance between those properties (detergency/foaming) can be reached by using surfactant mixtures.

Other examples of the amphoteric surfactants which can be used herein include amino acid, betaine, sultaine, sulfobetaines, carboxylates and sulfonates of fatty acids, phosphobetaines, imidazolinium derivatives, soybean phospholipids, and yolk lecithin. Examples of suitable amphoteric surfactants also include the alkali metal, alkaline earth metal, ammonium or substituted ammonium salts of alkyl amphocarboxy glycinates and alkyl amphocarboxypropionates, alkyl amphodipropionates, alkyl amphodiacetates, alkyl amphoglycinates and alkyl amphopropionates wherein alkyl represents an alkyl group having 6 to 20 carbon atoms. Other suitable amphoteric surfactants include alkyliminopropionates, alkyl iminodipropionates and alkyl amphopropylsulfonates having between 12 and 18 carbon atoms, alkylbetaines and amidopropylbetaines and alkylsultaines and alkylamidopropylhydroxy sultaines wherein alkyl represents an alkyl group having 6 to 20 carbon atoms are especially preferred.

Particularly useful amphoteric surfactants include both mono and dicarboxylates such as those of the formulae: 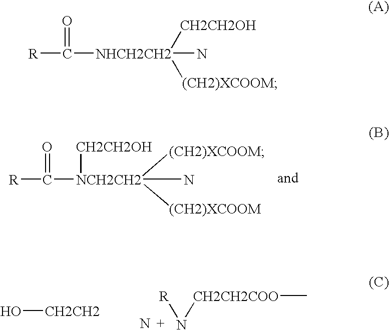
wherein R is an alkyl group of 6-20 carbon atoms, x is 1 or 2 and M is hydrogen or sodium. Mixtures of the above structures are particularly preferred.

Other formulae for the above amphoteric surfactants include the following: 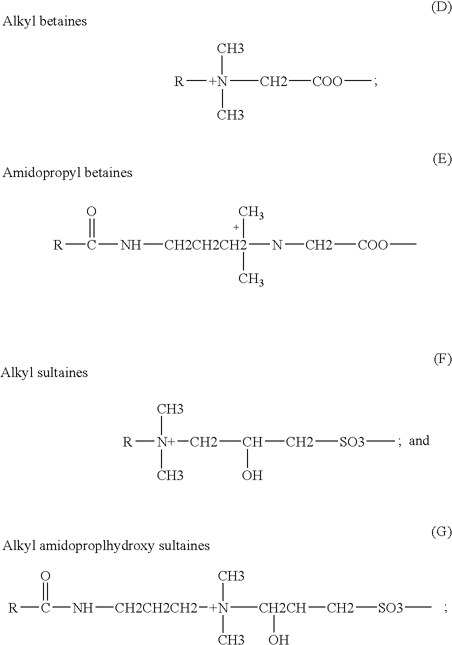
where R is an alkyl group of 6-20 carbon atoms and M is hydrogen or sodium.

Of the above amphoteric surfactants, other preferred amphoteric surfactants are the alkali salts of alkyl amphocarboxyglycinates and alkyl amphocarboxypropionates, alkyl amphodipropionates, alkyl amphodiacetates, alkyl amphoglycinates, alkyl amphopropyl sulfonates and alkyl amphopropionates wherein alkyl represents an alkyl group having 6 to 20 carbon atoms. Even more preferred are alkyl dimethyl betaines, alkyl amidopropyldimethyl betaines, alkyl dimethyl sulfobetaines or alkyl amidopropyidimethyl sulfobetaines, such as Mirataine CBS, sold by the company Rhodia, or the condensation products of fatty acids and of protein hydrolysates; or alkyl amphoacetates or alkyl amphodiacetates in which the alkyl group comprises from 6 to 20 carbon atoms.

The third component, sodium fluoride, is a scale activator. However, any suitable scale activator maybe used and is preferably selected from compounds that are known to react with insoluble silicates, polysilicates and even silica to form more readily soluble compounds. Fluoride ions from sodium fluoride will react with the scale to form fluorosilicates which are more easily solubilized or dispersed in the descaling solution. The fluoride ion source is not limited to sodium fluoride and other soluble fluorides can be used: potassium fluoride, ammonium bifluoride, hydrofluoric acid or phosphofluoric acid. Organic fluorides such as (p- m- or o-) fluorobenzoic acid or trifluoroacetic acid can also be used to achieve the same results. Scale activator compounds are also known to react with some metallic substrates by attacking the substrate or the oxide film that covers them. That process might help release more easily the silicate/polysilicate scale. Fluorides are effective for that purpose but other species can be added to the solution with or without the fluorides. For example, chlorides such as sodium chloride or hydrochloric acid can be added for that purpose.

It should be appreciated that other ingredients may be added to the solution to increase its descaling effectiveness or its compatibility with substrates of differing nature. They include chelating/sequestering agents (sodium gluconate, EDTA, triethanolamine, or the like), dispersants (for example, sodium polyacrylate) and corrosion inhibitors.

Polysilicate residue which may be effectively removed by the cleaning solution of the invention includes calcium silicate, magnesium, and other sodium metasilicate residue. Poultry processing equipment which is effectively cleaned by the solution of the invention includes metal surfaces of the equipment, and preferably includes stainless steel surfaces.

A method of cleaning in accordance with the invention includes contacting the equipment with the cleaning solution of the invention (as described above) at room temperature for about 30 minutes. No agitation is required to achieve the cleaning benefits of the invention in accordance with this method. The equipment may be contacted with the solution via dipping, spraying, soaking or any suitable manner to allow the solution to contact the equipment for between about 0.5 to about 60 minutes and preferably about 30 minutes. The time required to achieve desired results will depend on the method of application, concentration of the cleaning solution, nature of the scale and thickness of the scale. The equipment is preferably scrubbed after contact or treatment with the solution to remove any remaining polysilicate residue:

Another method of cleaning in accordance with the invention includes heating the cleaning solution of the invention (as described above) to an elevated temperature of at least about 130° F. and allowing the heated solution to contact the equipment for about 10 minutes. Using a heated solution in accordance with the invention has been shown to impart enhanced cleaning using shorter cleaning durations. Again, the equipment may be contacted with the solution via dipping, spraying, soaking or any suitable manner to allow the solution to contact the equipment for between about 0.5 to about 60 minutes and preferably about 10 minutes. The time required to achieve desired results will depend on the method of application, concentration of the cleaning solution, nature of the scale and thickness of the scale. After treatment with the heated solution, the equipment is preferably scrubbed to remove any remaining polysilicate residue.

Yet another method of cleaning in accordance with the invention includes heating the cleaning solution of the invention (as described above) to an elevated temperature of between about 130° F. and about 180° F., and preferably about 165° F. and allowing the heated solution to contact the equipment for between about 0.5 to about 60 minutes and preferably about 10 minutes. The time required to achieve desired results will depend on the method of application, concentration of the cleaning solution, nature of the scale and thickness of the scale. The solution is preferably agitated while in contact with the equipment. The use of heat and agitation has been shown to impart enhanced cleaning using shorter cleaning durations without the need for scrubbing after treatment. Accordingly, scrubbing after treatment is optional, but is not necessary to achieve satisfactory cleaning of the equipment. Again, the equipment may be contacted with the solution via dipping, spraying, soaking or any suitable manner to allow the solution to contact the equipment for about 10 minutes.

It should be appreciated that the solutions of the invention may be used in any appropriate cleaning situation including but not limited to industrial and institutional external cleaners, clean in place (CIP) bottle washing, pasteurizers, cooling water systems, and hard surface cleaners. It should also be appreciated that the compositions of the solutions of the invention may be varied according to the desired characteristics of the cleaning solution.

The following non-limiting examples will further illustrate the preparation and performance of the preferred compositions in accordance with the invention. However, it is to be understood that these examples are given by way of illustration only and are not a limitation of the invention.

### EXAMPLES

### Example I

A first stainless steel plate having light polysilicate film deposits thereon was cut into strips. A portion of one of the strips was immersed in a solution of 1% MIRATAINE JC HA in 5% sodium hydroxide and 0.5% sodium fluoride at a temperature of about 165° F. with mild stirring in the same manner as Example I. After about 10 minutes the strip was removed from the solution and rinsed with water. The immersed portion of the strip was clean but with some streaks.

### Example II

A portion of a strip from the first plate was immersed in a solution of 1% MIRATAINE JC HA in 5% sodium hydroxide and 1% sodium fluoride at a temperature of about 165° F. with mild stirring in the same manner as Example I. After about 10 minutes the strip was removed from the solution and rinsed with water. The immersed portion of the strip was clean and free of visible polysilicate deposits. The strip also exhibited shine.

### Example III

A second stainless steel plate having heavy polysilicate film deposits thereon was cut into strips. A portion of the strip from the second plate was immersed in a solution of 1% MIRATAINE JC HA in 5% sodium hydroxide and 0.5% sodium fluoride at a temperature of about 130° F. without any agitation. After about 10 minutes the strip was removed from the solution and scrubbed. After scrubbing the strip was rinsed with water. The immersed portion of the strip was clean with spots.

### Example IV

A portion of another strip from the second plate was immersed in a solution of 1% MIRATAINE JC HA in 5% sodium hydroxide and 0.5% sodium fluoride at room temperature without any agitation. After about 30 minutes the strip was removed from the solution and scrubbed. After scrubbing the strip was rinsed with water. The immersed portion of the strip was clean with some spots.

### Example V

A portion of another strip from the second plate was immersed in a solution of 1% MIRATAINE JC HA in 5% sodium hydroxide and 1% sodium fluoride at a temperature of about 130° F. without any agitation. After about 10 minutes the strip was removed from the solution and scrubbed. After scrubbing the strip was rinsed with water. The immersed portion of the strip was clean with some spots.

1. A cleaning composition for removing polysilicate residue from poultry processing equipment said composition comprising sodium hydroxide, sodium fluoride, and an amphoteric surfactant.

2. The composition of claim 1 comprising from about 3% to about 10% sodium hydroxide.

3. The composition of claim 2 comprising about 5% sodium hydroxide.

4. The composition of claim 1 comprising from about 0.5% to about 5% amphoteric surfactant.

5. The composition of claim 4 comprising about 1% amphoteric surfactant containing aminoproprionate.

6. The composition of claim 1 wherein said amphoteric surfactant comprises aminoproprionate.

7. The composition of claim 1 comprising from about 0.5% to about 5% sodium fluoride.

8. The composition of claim 7 comprising about 1% sodium fluoride.

9. The composition of claim 1 comprising from about 3% to about 10% sodium hydroxide; from about 0.5% to about 5% sodium fluoride; and from about 0.5% to about 5% amphoteric surfactant.

10. The composition of claim 1 comprising about 5% sodium hydroxide, about 1% sodium fluoride, and about 1% amphoteric surfactant.

12. The composition of claim 6 wherein said aminoproprionate is sodium alkyl aminoproprionate.

13. The composition of claim 6 wherein said aminoproprionate has an alkyl chain of from about C₄ to about C₁₂.

14. The composition of claim 13 wherein said alkyl chain is branched.

15. The composition of claim 13 wherein said alkyl chain is linear.

16. A method of removing polysilicate residue from a metal surface using an aqueous cleaning composition, said method comprising:
contacting said metal surface with an aqueous cleaning composition for at least about 30 minutes, wherein said aqueous cleaning composition comprises sodium hydroxide; an amphoteric surfactant; and sodium fluoride.

17. The method of claim 16 further comprising:
scrubbing said metal surface to remove any remaining polysilicate residue.

18. The method of claim 16 wherein said step of contacting comprises spraying, soaking or dipping.

19. A method of removing polysilicate residue from a metal surface using an aqueous cleaning composition, said method comprising:
(a) heating an aqueous cleaning composition to a temperature of at least about 130° F., said aqueous cleaning composition comprising sodium hydroxide, an amphoteric surfactant, and sodium fluoride; and
(b) contacting said metal surface with said heated aqueous cleaning composition for at least about 10 minutes.

20. The method of claim 19 further comprising:
scrubbing said metal surface to remove any remaining polysilicate residue.

21. The method of claim 19 further comprising agitating said aqueous solution while contacting said metal surface.

22. The method of claim 19 wherein said step of contacting comprises spraying, soaking or dipping.

23. The method of claim 19 wherein said heating comprises heating said aqueous solution to about 165° F.

24. A method of removing polysilicate residue from a metal surface using an aqueous cleaning composition, said method comprising:
(a) heating an aqueous cleaning composition to a temperature of at about 165° F., said aqueous cleaning composition comprising sodium hydroxide, an amphoteric surfactant containing aminoproprionate, and sodium fluoride; and
(b) contacting said metal surface with said heated aqueous cleaning composition for at least about 10 minutes.
